(19) United States
(12) Patent Application Publication
(10) Pub. No.: US 2015/0112982 A1
(43) Pub. Date: Apr. 23, 2015

(54) METHOD AND SYSTEM FOR GATHERING AND ANALYZING INFORMATION

(71) Applicant: Proust, LLC, New York, NY (US)

(72) Inventor: David Carson, Westport, CT (US)

(73) Assignee: Proust, LLC, New Yor, NY (US)

(21) Appl. No.: 14/514,867

(22) Filed: Oct. 15, 2014

Related U.S. Application Data
(60) Provisional application No. 61/893,041, filed on Oct. 18, 2013.

(51) Int. Cl. G06N 5/02; G06F 17/30

(52) U.S. Cl. CPC G06N 5/02; G06F 17/3053; G06F 17/30873; G06F 17/30867
USPC 707/731

(57) ABSTRACT

A method and system for gathering and analyzing information utilizing a preference list on a mobile user device.

### FIELD OF THE INVENTION

The invention relates to a method and system for gathering and analyzing information.

### BACKGROUND OF THE INVENTION

Conventional methodologies for gathering and analyzing information, like a question with an input field for entering/typing an answer, or a question with multiple-choices as pre-written answers, are complicated, slow, and require numerous steps to drill-down and achieve a deep insight. In addition, conventional methodologies are harder to administer because they require a large amount of text, and they are harder to distribute because their form factor is too long, which makes engagement low because nobody wants to spend the time reading and answering questions. Furthermore, conventional methodologies are like an undesirable test.

### SUMMARY OF THE INVENTION

An objective of the invention is to provide a simple and efficient methodology for gathering and analyzing information for anyone to administer, distribute, and engage.

Another objective of the invention is to provide an insight with few steps as possible.

The above objectives and other objectives can be obtained by a method of obtaining information comprising:
sending a list of terms representing a question to a mobile user device;
displaying on the mobile user device the list of terms in a format so that the terms can be prioritized using only a user's thumb;
prioritizing the list of terms by the user by using a thumb; and
determining from the prioritized list an answer.

The objectives and other objectives can also be obtained by a system for obtaining information comprising:
a server connected to a network, the cloud based server being in communication with or comprising at least one non-volatile memory, a database stored in the non-volatile memory, the database constructed to store questions and answers;
a user device in communication with the server via the network;
a question module constructed to display a question in the form of a list of terms on the user device in a format that the user can prioritize the terms using a thumb, wherein the question module is stored in the non-volatile memory;
a conjoint analysis module constructed to analyze an answer to the question, wherein the conjoint analysis module is stored in the non-volatile memory.

### BRIEF DESCRIPTION OF THE DRAWINGS

FIG. 1 illustrates a system according to the invention.

FIG. 2A illustrates an exemplary screen shot on a mobile user device showing how the Question Maker creates a Question.

FIG. 2B illustrates an exemplary screenshot on a mobile user device of what a question looks like to the user. The user drags each term into a new position that indicates their preference from Top (being best) and the Bottom (being worst).

FIG. 3A illustrates an exemplary screenshot on a mobile user device of how the question maker sends a question to a user, or group of users.

FIG. 3B illustrates an exemplary screenshot on a mobile user device of a comparison result after a user answers a question. In this specific case, the user is told that the user's preferences contrast significantly with either the question maker, or another user. A command to “Sort It Out” is used to convey the sentiment that their answers are misaligned.

### DETAILED DESCRIPTION OF THE INVENTION

The invention will now be explained with reference to the attached non-limiting drawings. The operations described in the Figs. and herein can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

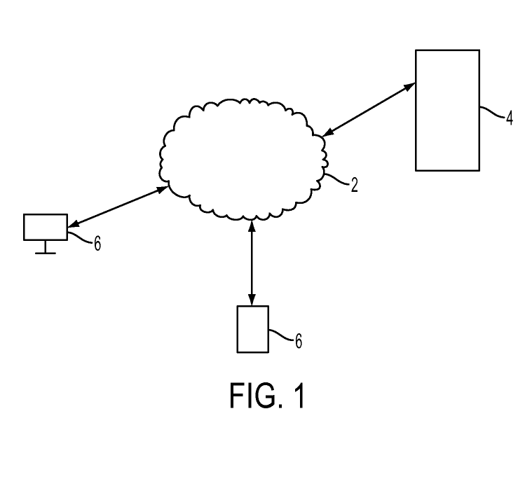

FIG. 1 describes a system comprising a server 4 connected to a network 2. User devices 6, such as mobile user device 6 or desktop computer 6 are also connected to the network 2. The mobile user device 6 includes, but is not limited to, the iPhone, Android, and Windows Phone, which have a touch screen. However, any user device 6 can be used that is capable of connecting to the server 4 via the network 2. Other examples of the user device 6 are tablets, iPads, Mac OS computers, Windows computers, and e-readers. The network 2 can be the internet, a local network, wifi, the telephone, or any other network.

The server 4 can include one or more computer systems directly connected to one another and/or connected over a network 2. Each computer system includes a processor, non-transitory tangible memory, user input and user output mechanisms, a network interface, and executable program code (software) comprising computer executable instructions stored in non-transitory tangible memory that executes to control the operation of the server 4. Similarly, the processors functional components formed of one or more modules of program code executing on one or more computers. Various commercially available computer systems and operating system software can be used to implement the hardware and software. The components of each server can be co-located or distributed. In addition, all or portions of the same software and/or hardware can be used to implement two or more of the functional servers (or processors) shown. The server 4 can run any desired operating system, such as Windows, Mac OS X, Solaris or any other server based operating systems. Other embodiments can include different functional components. In addition, the present invention is not limited to a particular environment or server 4 configuration. Preferably, the server 4 is a cloud based computer system

A database and system software are stored in the non-transitory tangible memory. The term “database” includes a single database and a plurality of separate databases. The server 4 can comprise the non-transitory tangible memory or the server 4 can be in communication with the non-transitory tangible memory storing the database. The database can be stored at different locations.

On a mobile user device, the quickest interactions are performed with the thumb. Thus, in a preferred embodiment, the invention utilizes mainly the thumb, even more preferably only the thumb, to enter input. In this regard, discrete “tiles” that one could move to order information from “best to worst” are used to create a list of your preferences extremely quickly. To administer a “question,” the question is converted from a sentence to be in the form of a list of terms. The terms can be distributed into a block of “tiles,” which can be displayed on the mobile user device 6. The playful nature of sorting the tiles from “best to worst” makes the “question” more engaging and fun to answer. The term “best to worst” includes “most desirable to least desirable,” “like more to like less” and other synonymous statements.

Questions are now asked in form of a list of terms, instead of a long sentence. Thus, the questions determine the list of terms. Terms are selected which are related to the desired question. By prioritizing the list of terms, the user is answering the question in detail. The questions are usually asked by a question maker, however, a user can provide additional questions. The questions and answers can be stored in the database. The question maker can enter questions into the database using any of the user devices 6 or server 4. The user preferably enters answers into the database using the mobile user device 6. The questions and answers can be transmitted using any of email, messaging, texting, or web based, or any other method as desired.

In addition, the “answer” (the sorted list) provides a deep insight because the list represents the user's relational preferences. The method provides a simplified and easy-to-use conjoint analysis tool. A way to determine preference within a cluster of varying, and sometimes seemingly unrelated, inputs. This new question and answer method is incredibly powerful for all kinds of applications. Conjoint analysis is now well known and any suitable conjoint analysis software and methods can be utilized to analyze the user preference lists.

In a preferred embodiment, the method has the ability to present a desired question to users with the use of multiple “tiles” filled with words/terms of the question maker's choosing so that the question is easy to understand and more enjoyable to engage with. The method provides a simple way to share the question with anyone with a mobile user device 6 and provides a fast, easy way to answer the question by simply sorting “tiles” with terms/words from best to worst using a thumb. An immediate compare/contrast mechanism can be provided for the question maker (and/or question sharer) and the people who answered the question.

It is now well known how to send and receive information from a mobile user device 6. Any conventional method of sending and receiving information from a mobile user device 6 can be used. The term list can be sent to a mobile user device 6 using any desired method, such as email, messaging, or other application. After the user prioritizes the term list, the prioritized list can be sent to the database on the server 4 or to any other location as desired using any desired method, such as email, messaging, or other application.

A question maker and users can download software from the server 4 and run the software on the user device 6, mobile or desktop. The question maker can use the software to create, send and log question results, as well as have the ability to chat and discuss answers with users. The users can use the software to answer questions from the question maker and see their compared results with other users, as well as chat/discuss with the question maker and other users.

The user has the ability to share any question with other users, and can invite other to become users as well. This provides the question maker the ability to scale users more rapidly and gain access to a wider network of users.

The question makers can implement the method into their own applications, mobile or desktop. The software uses the server to process the exchange of questions and answers, result comparisons, and the ability to chat and discuss. The question maker has the ability to change the look and function of the software to better customize the method to their own software environments.

The methods described herein can be encoded in software and stored on the non-volatile memory of the server 4. For example, a question module constructed to display a question in the form of a list of terms on the user device in a format that the user can prioritize the terms using a thumb can be stored in the non-volatile memory. A conjoint analysis module constructed to analyze an answer to the question can be stored in the non-volatile memory.

The invention will now be explained with reference to the following non-limiting examples.

### EXAMPLE 1

The method can be used to quickly determine compatibility. In one experimental test of this application, a male and a female, who did not know each other, used the method to determine compatible values, interests and morals, and wound up dating as a result.

Terms were selected by the question maker by their ability to show contrast in popular culture, moral standards, intelligence, and sense of humor. Users were found to be compatible by the level of discourse they had after each compared answer, as well as their ability to match answers. User's were also allowed to be the question maker, where they determined the criteria for terms and could use the methodology to vet a user even more, but in a personalized, customizable way. Through this approach, users could ask very personal questions more effectively. Users were able to ask questions that might otherwise seem off-putting, or risque, to another user, because they could combine the more risque terms with more non-risque terms.

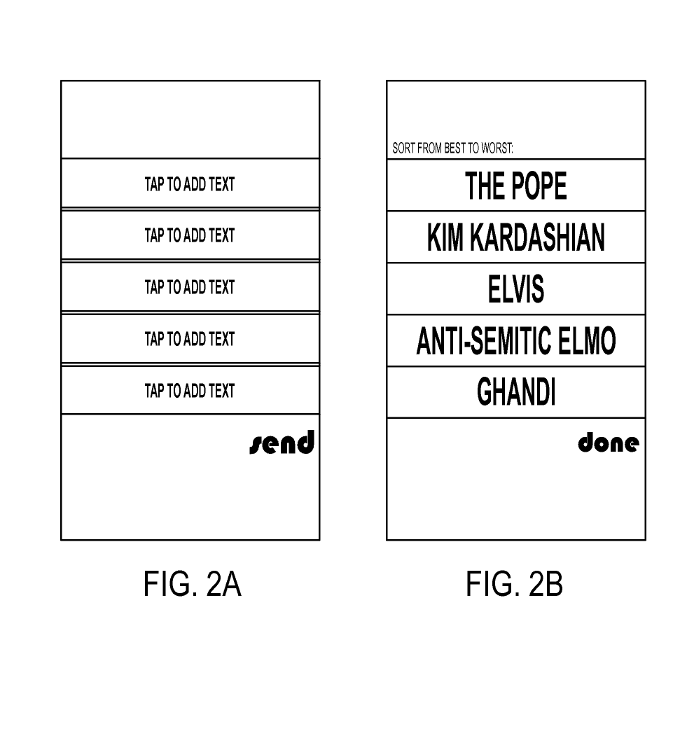

The user (now also a question maker) could ask a question with the following terms shown in FIG. 2B:

### THE POPE

### KIM KARDASHIAN

### ELVIS

### ANTI-SEMETIC ELMO

### GHANDI

How a user answers by sorting these terms by moving the tiles into the spaces shown in FIG. 2A can quickly determine the users religious, political, and pop-culture proclivities to the question maker, and it does so quickly, playfully, and in a non-threatening format.

Ordering as:

### KIM KARDASHIAN

### ANTI-SEMETIC ELMO

### ELVIS

### GHANDI

### THE POPE

Provides a different answer than a user ordering the terms as follows:

### THE POPE

### ELVIS

### GHANDI

### ANTI-SEMETIC ELMO

### KIM KARDASHIAN

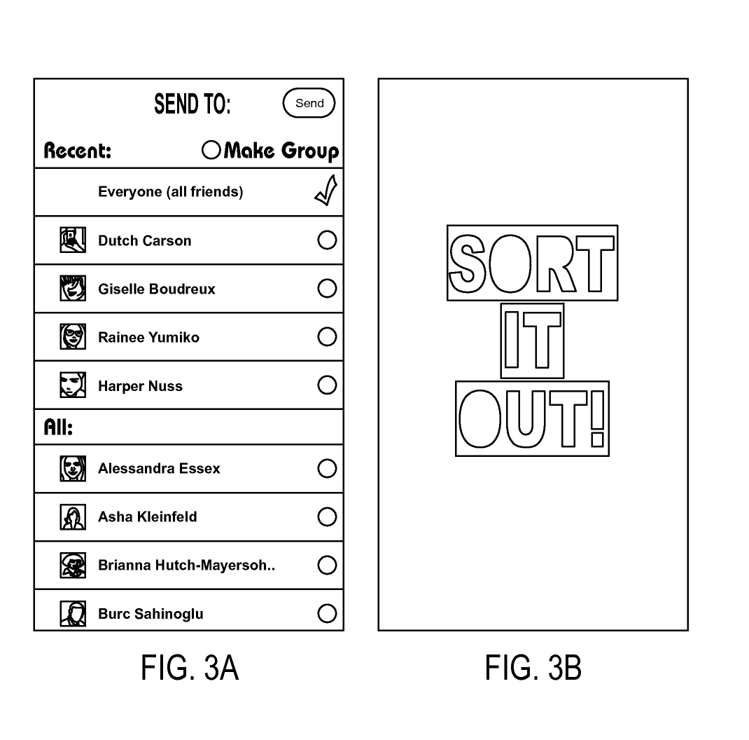

FIG. 3A shows an exemplary screen shot on a mobile user device of how the question maker can send the question to different users. FIG. 3B shows the results of a comparison of answers in which the user is told that the user's preferences contrast significantly with either the question maker, or another user. A command to “Sort It Out” is used to convey the sentiment that their answers are misaligned.

### EXAMPLE 2

The method can be used to quickly drive management decisions. A chief executive officer (CEO) currently tested the method to compare and contrast priorities with his direct reports. The CEO used the test method to replace the CEO's former methodology known as the “5-15” where the CEO asks his direct reports to take 15 minutes to write a report for the week that the CEO could review. The report had to be something the CEO could read in 5 minutes. The CEO would use that exchange as a means to compare/contrast his priorities for the company against the employees priorities. By using the method, the COEO and his employees drastically cut the time it takes to obtain that level of insight. As well, they were able to see their contrasting/compared results immediately and discuss quickly.

The question maker, in this case the employee (direct report to CEO), chose terms that related to the business objectives for the week. The question maker was able to sort the terms in order of the question maker's own priorities. Then the question maker sent the unsorted list (question) to the CEO. The CEO sorted through the question maker's terms and sent the CEO's own answer to the servers. The software sends the employee and the CEO the results. The possible results are:

Twinsies (complete match. terms are sorted exactly in order by each).
Awesome Sandwich (matching top/best and bottom/worst, but middle priorities do not match).
Bi-Polar (what the CEO put on Top and Bottom is in opposition to what Employee put on Top and Bottom—for example if CEO puts “Get Sales Up in Detroit” on Top and “Hire New HR Head” on the Bottom—and the Employee puts “Hire New HR Head” on Top and “Get Sales Up in Detroit” on the Bottom).
Opposite (like Bi-Polar, but only if a User's top is the other User's bottom, and not vice-versa).
Tops (there is alignment for the Top term, but nothing else).
Bottoms (there is alignment on the last term, but nothing else).
Epic Nothing (nothing is aligned).

Upon viewing the results of their compared answers, the CEO and the employee can discuss in the software how best to align priorities.

### EXAMPLE 3

The method can be used to quickly compare similar, or contrasting ideas to determine how they best relate to each other. For example, a hotel marketer can determine what aspects of the hotel customers prefer over others. A boring long survey is not desirable because most of the customers will not even bother responding. The term list in the present method can be used to answer the question. Exemplary terms include new feather mattresses, the vodka bar downstairs, the art on the walls, the location, the service, etc. The preference lists provided by the customers (users) can provide an insight regarding what the customers liked and did not like about the hotel. The method can be used to determine the preference and priorities of the customers very quickly and efficiently. For example, one might find that customers prioritize service over the location over the vodka bar over the new feather mattresses over the art on the walls. In this case, the hotel may use this insight to invest less on the art and more on improving services, or to market the vodka bar more than the feather mattresses.

These are just a few non-limiting exemplary demonstrations. The list of applications is unlimited. The method provides speed, simplicity, high engagement, and the ability to deliver deep insights, compared to conventional methods.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, s and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. A method of obtaining information comprising:
sending a list of terms representing a question to a mobile user device;
displaying on the mobile user device the list of terms in a format so that the terms can be prioritized using only a user's thumb;
prioritizing the list of terms by the user by using a thumb; and
determining from the prioritized list an answer.

2. The method according to claim 1, further comprising converting a question to the list of terms.

3. The method according to claim 1, wherein the list of terms is displayed on the mobile user device in the form of tiles.

4. The method according to claim 1, further comprising comparing a plurality of answers.

5. A system for obtaining information comprising:
a server connected to a network, the cloud based server being in communication with or comprising at least one non-volatile memory, a database stored in the non-volatile memory, the database constructed to store questions and answers;
a user device in communication with the server via the network;
a question module constructed to display a question in the form of a list of terms on the user device in a format that the user can prioritize the terms using a thumb, wherein the question module is stored in the non-volatile memory;
a conjoint analysis module constructed to analyze an answer to the question, wherein the conjoint analysis module is stored in the non-volatile memory.

6. A computer readable medium storing instructions executable by a computing system including at least one server and user device, wherein execution of the instructions implements a method according to claim 1.
